(19) United States
(12) Patent Application Publication
(10) Pub. No.: US 2017/0161747 A1
(43) Pub. Date: Jun. 8, 2017

(54) SYSTEMS AND METHODS FOR DYNAMICALLY PROCESSING E-WALLET TRANSACTIONS

(71) Applicant: OFFLA SELFSAFE LTD., Tel Aviv (IL)

(72) Inventors: Ori Einhorn, Efrat (IL); Yuval Raz, Kfar Ha Oranim (IL); Nachshon Margaliot, Elkana (IL)

(73) Assignee: OFFLA SELFSAFE LTD.

(21) Appl. No.: 15/185,599

(22) Filed: Jun. 17, 2016

Related U.S. Application Data
(60) Provisional application No. 62/262,347, filed on Dec. 2, 2015.

(51) Int. Cl. G06Q 20/40; G06Q 20/32; G06Q 20/36

(52) U.S. Cl. CPC G06Q 20/4016; G06Q 20/36; G06Q 20/322

(57) ABSTRACT

The disclosed embodiments include systems, methods, and computer-readable media configured to dynamically process transactions initiated or requested from a mobile device. The techniques described in the disclosed embodiments may be used, for example, to process e-wallet transactions based on localized and/or offline fraud detection. Thus, the techniques may be used to improve fraud detection and to provide dynamic processing of e-wallet transactions.

### CROSS REFERENCE TO RELATED APPLICATIONS

This application claims the benefits of prior filed U.S. Provisional Application No. 62/262,347, filed Dec. 2, 2015, the content of which is incorporated herein by reference.

### TECHNICAL FIELD

The present disclosure relates generally to computerized systems and methods for electronic fraud detection and prevention and, more particularly, to systems and methods for dynamically processing e-wallet transactions based on fraud detection.

### BACKGROUND

The Internet and the prevalence of mobile devices have transformed how people communicate and conduct transactions. Not only are people increasingly connected to the Internet, but more and more devices are also being inter-connected to each other and to the Internet. However, due to the anonymous nature of the Internet and computer systems in general, the process of identifying a mobile device user in transactions involving a mobile device remains susceptible to fraud. Indeed, one with access to the mobile device may pose as the user. Thus, in order to prevent an unauthorized person from using the mobile device, additional authentication processes are often needed to verify the mobile device user.

This is especially true in situations where it is imperative to ensure that only an authorized person is using the mobile device. For example, proper verification is important when the person using a mobile device requests confidential information, executes financial transactions, restores passwords, or conducts other secure transactions, etc. However, current technologies either require the user to carry an additional security device, such as a RSA token or smartcard, or require the mobile device to be connected to a remote authentication server, such as in the case of a two-step authentication procedure. As a result, these authentication processes are too cumbersome for mobile device users and/or require the mobile devices to be online.

Accordingly, there is a need for an offline solution to improve the security of communications and transactions taking place with mobile devices that is highly secure, user-friendly, fast, and reliable. Moreover, especially with financial transactions where current technologies require a remote server to process the transactions and detect fraud, there remains a need for a localized and/or offline solution capable of processing financial transactions involving the mobile device, such as e-wallet transactions, without having to access a remote server.

### SUMMARY

The disclosed embodiments include systems, methods, and computer-readable media configured to dynamically process transactions initiated from a mobile device. In particular, the techniques described in the disclosed embodiments may be used to process e-wallet transactions based on localized and/or offline real-time fraud detection. Thus, the techniques may be used to improve fraud detection and to provide dynamic processing of e-wallet transactions.

In the disclosed embodiments, a system may enable initiation of a financial transaction from a mobile communications device or from a point-of-sale (POS) device. In one aspect, a user's credit account information, for example, is stored in the mobile communications device for electronic communication to a merchant. The disclosed embodiments may receive, in the mobile communications device, transaction data associated with the financial transaction. In a further aspect, the disclosed embodiments may access behavioral profile data stored in the mobile communications device. For example, the behavioral profile data may include information about behaviors of individuals other than the user. In a further aspect, the disclosed embodiments may compare the transaction data with a behavioral model based on the behavioral profile data.

In a further aspect, based on the comparison, the disclosed embodiments may determine, in the mobile communications device, a risk of fraud associated with the financial transaction. Based on the determined risk of fraud, the disclosed embodiments may enable liability for the financial transaction to be shifted from the merchant to an issuer of the credit account (or another financial institution associated with the credit account), or vice versa. Similarly, portions of the risk may be shifted, so that the merchant or issuer bears a portion (e.g., percentage) of the risk of fraud.

In a further aspect, the disclosed embodiments may check the determined risk of fraud against at least one threshold. For example, the disclosed embodiments may shift the liability to the issuer only if the determined risk of fraud passes the at least one threshold. In a further aspect, the disclosed embodiments may enable the merchant to make an ultimate determination over whether risk should be shifted to the issuer. For example, the disclosed embodiments may enable the merchant to shift the liability risk to the issuer at a cost to the merchant. In a further aspect, the disclosed embodiments may prompt the user to provide additional security information. In such an aspect, the disclosed embodiments may determine the risk of fraud, for example, based on the behavioral profile data and the additional security information. In a further aspect, if the requested financial transaction is determined to be fraudulent, the disclosed embodiments may determine a proportion of liability to be borne by the merchant. In a further aspect, the disclosed embodiments may offer a discount to a merchant associated with the requested financial transaction based on the risk of fraud.

In some embodiments, all or some of the above functionality may be performed offline by a mobile device and/or POS device. In this manner, for example, the processing may occur without requiring a connection to a remote fraud-detection server. Instead, the processing may occur local to the transaction and/or offline.

The techniques described in the disclosed embodiments may be performed by any apparatus, system, or article of manufacture. It is understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a schematic diagram of an exemplary system that may be used to provide dynamic processing of e-wallet transactions in accordance with disclosed embodiments.

FIG. 2 is a schematic diagram of another exemplary system that may be used to provide dynamic processing of e-wallet transactions in accordance with disclosed embodiments.

FIG. 3 is a flowchart illustrating an exemplary sequence of steps that may be performed for performing offline fraud detection for e-wallet transactions in accordance with disclosed embodiments.

FIG. 4 is a flowchart illustrating an exemplary sequence of steps that may be performed for providing fraud detection in accordance with disclosed embodiments.

FIG. 5 is a flowchart illustrating an exemplary sequence of steps that may be performed for dynamically processing e-wallet transactions in accordance with disclosed embodiments.

FIG. 6 is a flowchart illustrating another exemplary sequence of steps that may be performed for dynamically processing e-wallet transactions in accordance with disclosed embodiments.

### DESCRIPTION OF THE EMBODIMENTS

The disclosed embodiments provide improved techniques for providing authentication of financial transactions and, more particularly, systems and methods for dynamically processing e-wallet transactions. The resulting systems and methods provide enhanced security, usability, quickness, and fraud detection as well as offline and/or localized processing of e-wallet transactions.

As used herein, the terms “mobile communications device” and “mobile device” broadly include any portable computing device having at least one processor, memory, and a capability for data communication. Mobile devices may include, but are not limited to, a mobile phone, smartphone, personal digital assistant, tablet, laptop, portable device, etc. In embodiments discussed herein, such mobile devices may engage in financial transactions with merchants (e.g., via communications with POS devices).

As used herein, the term “merchant” broadly includes any person or entity accepting payment in exchange for providing goods or services. Merchants may provide or use a variety of types of machines for accepting payment. For example, merchants may use POS devices that magnetically or electronically read information from a purchaser's credit or debit card. Such devices may also communicate with a purchaser's mobile device to perform a transaction. Such communications may use near-field communications (NFC), RFID, RF, Bluetooth®, infrared, or other similar communications techniques, whether now known or developed in the future.

As used herein, the terms “mobile transaction” and “financial transaction” broadly includes any electronic communication for requesting, or processing, a payment request or payment confirmation. For example, financial transactions may include, but are not limited to, a debit card transaction, credit card transaction, prepaid card transaction, e-commerce transaction, contactless payment transaction, etc.

As used herein, the term “transaction data” broadly includes any electronic data associated with a financial transaction. Transaction data may include, but is not limited to, a purchase price, purchase item identifier, mobile device identifier, POS device identifier, date, time, geographic location, merchant identifier, personal data associated with a purchaser, or any other information directly or indirectly related to a financial transaction.

As used herein, the terms “behavioral profile data”, “behavioral profile,” and “behavioral information” broadly include any electronic data associated with the actual or expected behavior of an individual. For example, in exemplary embodiments, behavioral information may include data identifying previous financial transactions in which a user has engaged and/or associated transaction data; and/or nonfinancial information, such as information about a geographic location of the user, time, date, weather, biometrics (e.g., heart rate, body temperature, etc.), or other calendar or environmental information. More generally, behavioral information may include any data directly or indirectly indicative of an individual's identity or conduct, including but not limited to information relating to the individual's use of email, phone, text, social media, or other apps or mobile device usage; information relating to contacts; information received from sensors in a mobile communications device; information about how and/or when the user enters data; information about the user's current behavior, past behavior, habits or idiosyncrasies; or any other data that provides insights as an individual's identity. In some embodiments, behavioral information may include behavioral data associated with users determined to have engaged in fraudulent activity. In other embodiments, behavioral information may include behavioral data associated with one or more users determined to have behavioral characteristics similar to those of another user.

Reference will now be made in detail to exemplary embodiments, examples of which are illustrated in the accompanying drawings and disclosed herein. Whenever convenient, the same reference numbers will be used throughout the drawings to refer to the same or like parts.

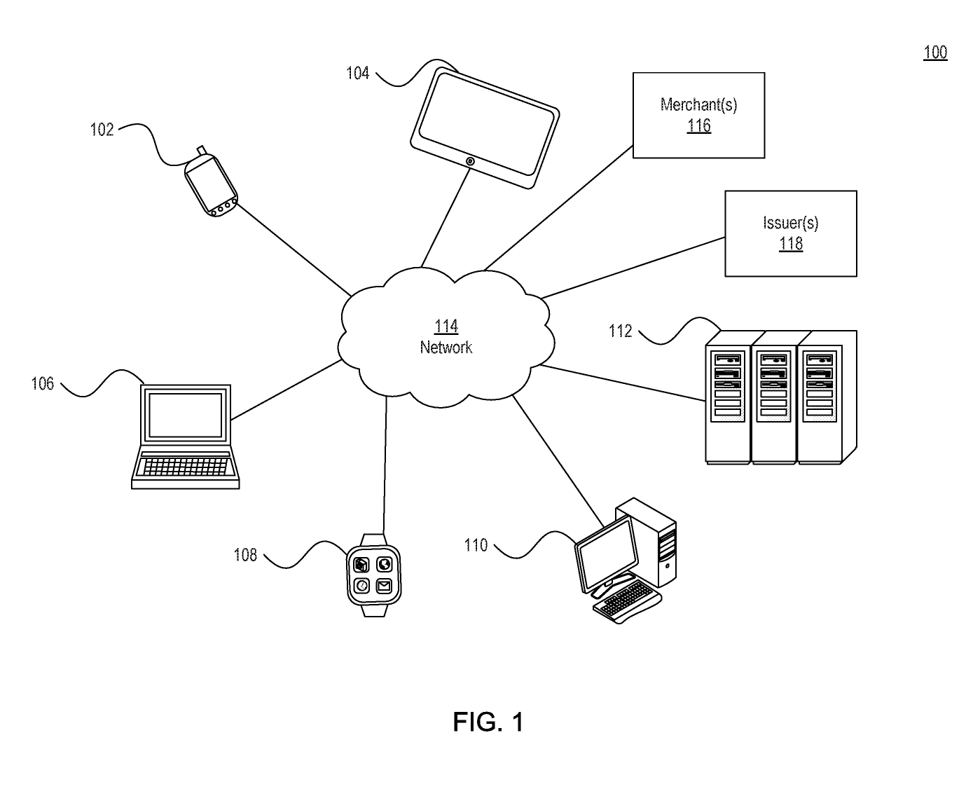

FIG. 1 is a diagram of an exemplary system 100 for performing one or more operations in accordance with the disclosed embodiments. The system 100 may comprise various components including one or more computing devices, such as computers, web servers, general-purpose servers, authentication servers, etc. The system 100 may further include memories for storing data and/or software instructions, such as RAM, ROM, databases, other computer memory devices, or the like, and may include other known computing components.

According to some embodiments, the system 100 may include one or more mobile communications devices 102, 104, 106, and 108 of various sizes and configurations. Although the mobile communications devices 102, 104, 106, and 108 are shown as a smartphone, tablet, laptop, and smartwatch for exemplary purposes of this description, it will be understood that other types of portable computing devices may also or alternatively be used in embodiments in accordance with this disclosure. As an additional example, the system 100 may also include various smart devices, such as “Internet of Things” (loT) devices (not shown), which are capable of data communication. In some embodiments, the system 100 may also include one or more computers 110 and/or servers 112.

As shown in FIG. 1, in some embodiments, the system 100 may also include one or more merchants 116 and/or issuers 118. It is to be understood that associated with the one or more merchants 116 may be various acquirers (e.g., various acquiring banks or financial institutions) that process the financial transactions on behalf of the one or more merchants 116. Furthermore, the one or more issuers 118 may be various banks or financial institutions where the users of the mobile device currently have payment accounts (e.g., credit card accounts, debit accounts, money market accounts, etc.). In some embodiments, some or all of the system 100 may be operated, for example, by the merchants 116 and/or issuers 118. In other embodiments, some or all of the system is operated by the user of the mobile device. In one aspect, the merchants 116 and/or issuers 118 may include one or more computing devices, memory for storing data and/or software instructions, and may include other known computing components, such as computers 110, servers 112, or the like for processing financial transactions. It will also be apparent to those skilled in the art that, although not shown in FIG. 1, merchants 116 may include automated teller machines (ATM), POS devices, contactless payment terminals, or the like for processing financial transactions.

The mobile communications devices 102, 104, 106, and 108, computers 110, servers 112, merchants 116, and/or issuers 118 in the system 100 may be configured to communicate with one or more components in the system 100 via a network 114. The network 114, in some embodiments, may comprise one or more interconnected wired or wireless data networks. In one aspect, the network 114 may comprise any type of computer networking arrangement used to exchange data. For example, the network 114 may be implemented using the Internet, a wired Wide Area Network (WAN), a wired Local Area Network (LAN), a wireless WAN (e.g., WiMAX), a wireless LAN (e.g., IEEE 802.11, Bluetooth, etc.), a mobile network, a private data network, a virtual private network using a public network, and/or other suitable connection (e.g., NFC, infrared, etc.) that enables the system 100 to send and receive information between the components in the system 100. In a further aspect, the network 114 may comprise any type of card processing networks for processing financial transactions. For example, the network 114 may be a network used by MasterCard®, Visa®, American Express®, or Discover®, etc., or may be an interbank network, debit network, or the like. In the example of American Express® and Discover®, for instance, the issuing bank and the acquiring bank may be the same entity.

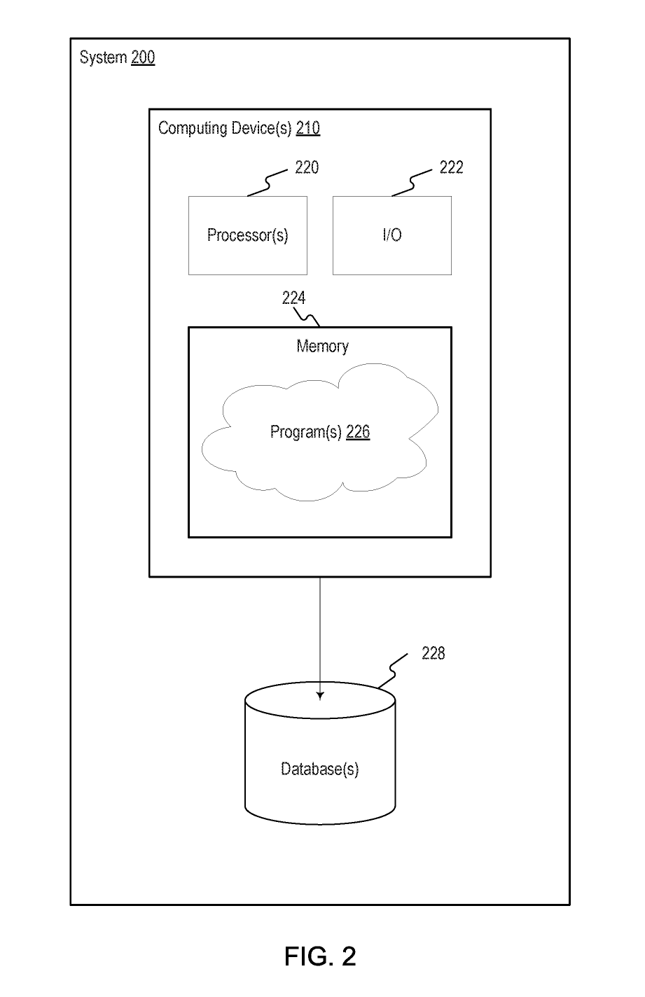

FIG. 2 is a diagram of another exemplary system for performing one or more operations in accordance with the disclosed embodiments. The exemplary system 200 or variations thereof may be implemented by one or more of the components in the system 100 (shown and not shown), including the mobile devices 102, 104, 106, and 108, smart devices, computers 110, and/or servers 112.

In some embodiments, the system 200 may include a computing device 210 having one or more processors 220, one or more input/output (I/O) devices 222, one or more memories 224, and one or more databases 228. In some embodiments, the computing device 210 may take the form of a mobile device, IoT device, personal computer, etc., or any combination of these components. Alternatively, computing device 210 may be configured as a particular apparatus, embedded system, dedicated circuit, or the like based on the storage, execution, and/or implementation of the software instructions that perform one or more operations consistent with the disclosed embodiments. In some embodiments, the system 200 may be a system-on-a-chip (SoC).

Processor 220 may include one or more known processing devices. For example, the processor 220 may take the form of, but not limited to, a microprocessor, embedded processor, or the like, or alternatively, the processor 220 may be integrated in an SoC. Furthermore, according to some embodiments, the processor 220 may be from the family of processors manufactured by Intel®, AMD®, Apple®, or the like. In some embodiments, the processor 220 may be a mobile processor.

I/O devices 222 may include one or more integrated ports or stand-alone devices configured to allow data to be received and/or transferred by computing device 210. In some embodiments, the I/O devices 222 may comprise a touchscreen configured to allow a user to interact with the computing device 210. In some embodiments, the I/O devices 222 may include one or more communication devices and/or interfaces (e.g., WiFi, Bluetooth®, RFID, NFC, RF, infrared, etc.) to communicate with other machines and devices, such as the components in the system 100. I/O devices 222 may also comprise sensors, such as gyroscopes, accelerometers, thermometers, cameras, scanners, etc.

Memory 224 may include one or more storage devices configured to store instructions used by the processor(s) 220 to perform functions related to the disclosed embodiments. For example, the memory 224 may be configured with one or more software instructions, such as included in program(s) 226, that may perform one or more operations when executed by the processor(s) 220 to provide authentication of a user or related functionality. The disclosed embodiments are not limited to separate programs or computers configured to perform dedicated tasks. For example, the memory 224 may include a single program 226 that performs the functions of the computing device 210, or alternatively, the memory 224 may include multiple software programs. Additionally, the processor 220 may execute one or more programs (or portions thereof) remotely located from the computing device 210. For example, the computing device 210 may access one or more remote programs, such that, when executed, the remote applications perform at least some of the functions related to the disclosed embodiments. Furthermore, the memory 224 may include one or more storage devices configured to store data for use by the program 226.

Computing device 210 may also be communicatively connected to one or more databases 228. For example, the computing device 210 may be communicatively connected to a database 228 through the network 114. The database 228 may include one or more memory devices that store information and are accessed and/or managed through the computing device 210. The systems and methods of the disclosed embodiments, however, are not limited to separate databases. In one aspect, the system 200 may include database 228. Alternatively, the database 228 may be located remotely from the system 200. The database 228 may include computing components (e.g., database management system, database server, etc.) configured to receive and process requests for data stored in the memory devices of the database 228 and to provide data from the database 228.

It is to be understood that the configuration and boundaries of the functional building blocks of the systems 100 and 200 have been described herein for the convenience of the description. Alternative boundaries may be defined so long as the specified functions and relationships thereof are appropriately performed. For example, the system 200 may constitute a part of components in the system 100 other than those specifically described, or may constitute a part of multiple components in the system 100. Such alternatives fall within the scope and spirit of the disclosed embodiments.

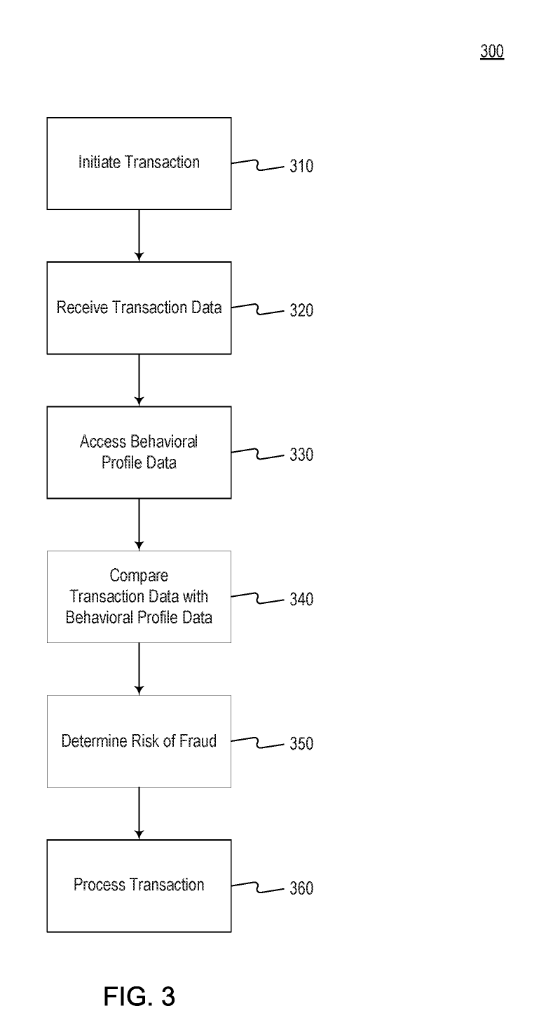

FIG. 3 shows a flowchart illustrating a sequence of steps that performs exemplary process 300 for performing offline and/or localized fraud detection and prevention of e-wallet transactions in accordance with disclosed embodiments. The process of FIG. 3 may be implemented in software, hardware, or any combination thereof. For purposes of explanation and not limitation, the process 300 may be described in the context of a mobile communications device in the system 100, such that the disclosed process may be performed by software executing in mobile devices 102, 104, 106, and 108, for example, as an e-wallet transaction.

In an e-wallet transaction, a mobile device user may use a mobile communications device in the system 100 to purchase a product or service from a merchant 116. The merchant 116 may provide a product or service for purchase either online (e.g., an e-commerce transaction via a web-based store on the Internet or via an application and/or software running on the user's mobile communications device) or in person (e.g., an in-store transaction at a conventional brick-and-mortar store, pop-up retailer, or the like). In the system 100, the user's credit or debit account information may be stored in the mobile communications device for electronic communication to the merchant 116. Thus, the system 100 may enable the user to request or initiate a financial transaction from the mobile communications device in-stores and/or for e-commerce transactions at step 310.

In some embodiments, a component of the system 100 may transfer transaction data associated with the requested transaction from the merchant to the mobile communications device (or vice versa) at step 320 for fraud prediction. After the mobile communications device receives the transaction data, the system 100 may initiate the fraud prediction process at step 330. For example, the mobile communications device may access behavioral profile data to predict the likelihood of fraud.

In some embodiments, the behavioral profile data may be stored in the mobile communications device in advance. For example, the mobile communications device may receive, from a server 112 in the system 100, behavioral profile data during an initial setup process, or during periodic or arbitrary updates. In some embodiments, the mobile communications device may generate the behavioral profile data (or portions thereof) based on the user's activities across the mobile device's applications. For example, the mobile communications device may gather information relating to the user's locations, calendar events, etc. The mobile communications device may also gather information related to the user's purchasing and spending habits, including but not limited to the time, date, and place of the purchases, the spending categories, the spending amounts, etc. Thus, by storing the behavioral profile data in the mobile communications device, one or more components of the system 100 may provide real-time fraud prediction in the mobile communications device without resorting to the network 114 or utilizing a central authentication server in the system 100. In some embodiments, the mobile communications device may access behavioral profile data stored remotely in one or more components of the system 100 on an as-needed basis, such as when the mobile communications device is within the communication coverage of network 114.

The behavioral profile data may be considered as a collection of events. For example, a user's typical activities tend to follow an expected pattern: the user tends to shop at the same stores, eat at the same restaurants, and call the same people, etc. Furthermore, the user's activities tend to be largely located at the same places. By gathering information related to the user's activities, one or more components of the system 100 may generate a profile of the user's behavior information. Thus, in one aspect, the behavioral profile data may include information about the actual or expected behaviors of the user. However, in another aspect, the behavioral profile data may include information about behaviors of individuals other than the user. For example, if the user is a male of a particular nationality, the behavioral profile data may include behaviors of other individuals of the same sex and nationality, or alternatively, the behaviors of other individuals of other sex and/or nationality. In a further aspect, the information may be about behaviors of individuals based on the user's status, profession, education, age, or the like. In another aspect, the behavioral data, for example, may be associated with other individuals determined to have engaged in fraudulent activity. For example, the behavioral information may describe the behavior profile of fraudulent persons and/or specific predefined customer rules. In yet another aspect, the behavioral information may be associated with one or more users determined to have behavioral characteristics similar to those of the user.

Using the behavioral profile data, at step 340, one or more components of the system 100 may compare the transaction data with the behavioral profile data to predict whether the transaction is fraudulent. Such a comparison may allow one or more components of the system 100 to determine the likelihood that the current transaction is a normal or abnormal event at step 360. In some embodiments, components of the system 100 may apply various statistical methods, including but not limited to correlation and reduction analyses, to calculate the likelihood that the transaction is fraudulent. For example, one or more components of the system 100 may determine that the transaction is fraudulent based on the deviation from the user's regular behavior. In doing so, one or more components of the system 100 may determine a risk of fraud associated with the transaction in real-time.

In some embodiments, one or more components of the system 100 may prompt the user to provide additional security information. For example, the system 100 may determine that a higher level of security is needed and initiate an additional authentication process. The authentication process may include, but is not limited to, entering a code received from the server 112 in one or more components of the system 100, a user pin, or the like. In some embodiments, the authentication process may be a security challenge presented to the mobile device user. In such an embodiment, the system 100 may determine the risk of fraud based on the behavioral profile data and the additional security information.

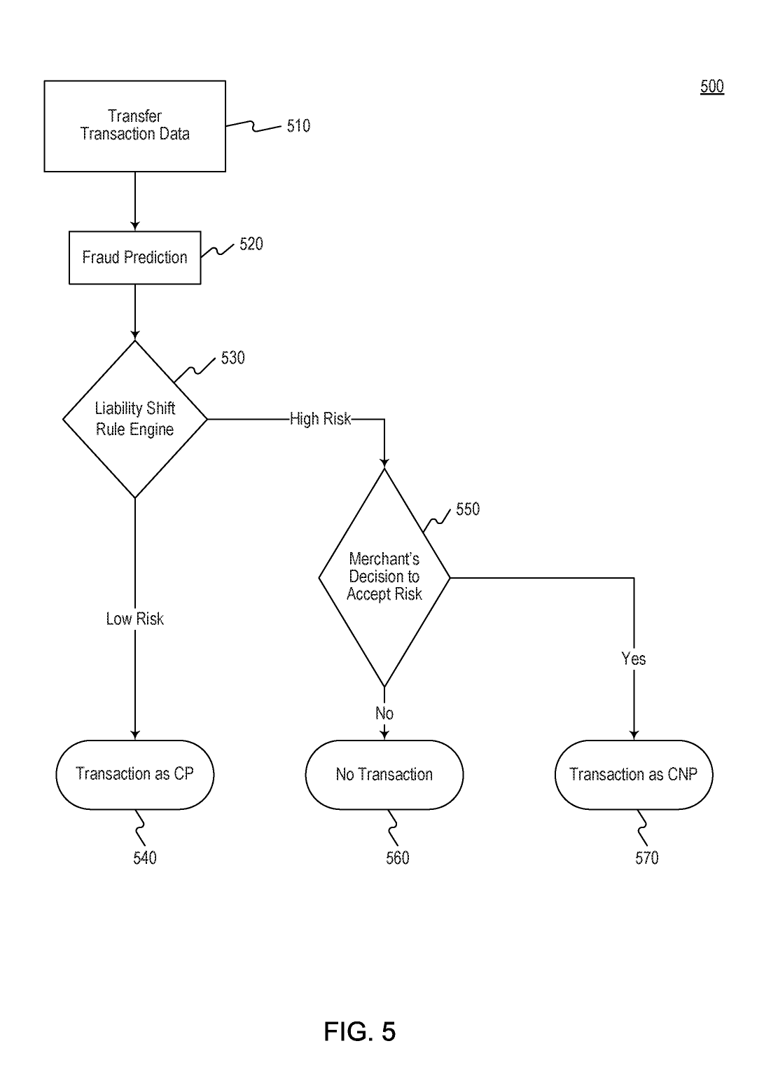

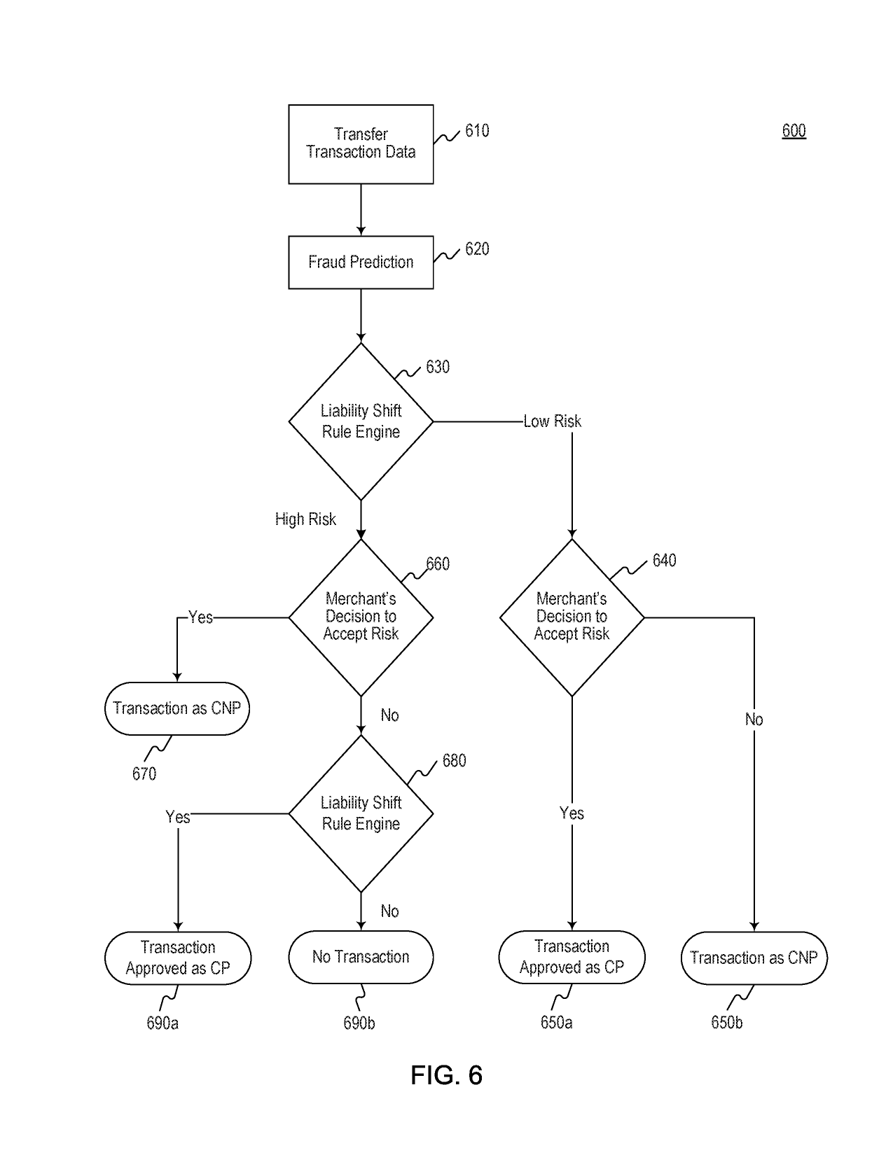

At step 360, one or more components of the system 100 may proceed to process the transaction based on the determined risk of fraud. For example, if the risk of fraud is acceptably low, components of the system 100 may approve the transaction. Alternatively, if the risk of fraud is unacceptably high, the system 100 may deny the transaction. Additional details related to dynamically processing the transaction are further described with respect to FIGS. 5 and 6.

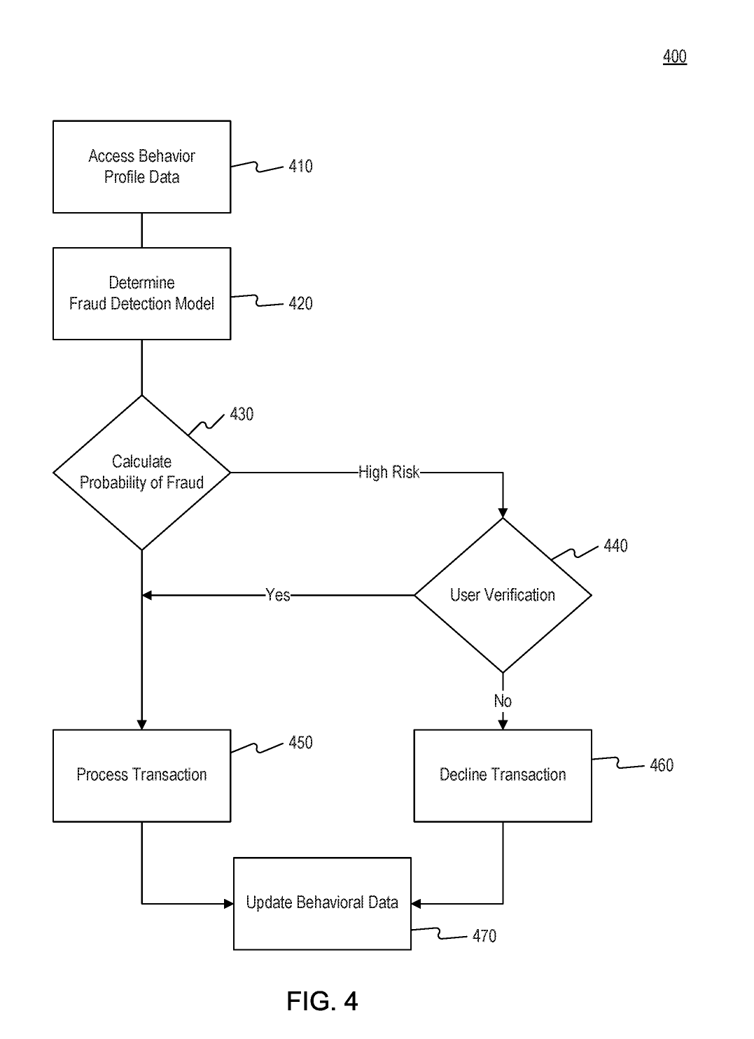

FIG. 4 shows a flowchart illustrating a sequence of steps that performs exemplary process 400 for providing fraud detection in accordance to disclosed embodiments. The process of FIG. 4 may be implemented in software, hardware, or any combination thereof. For purposes of explanation and not limitation, the process 400 will be described in the context of a mobile communications device in the system 100, such that the disclosed process may be performed by software executing in mobile devices 102, 104, 106, and 108, for example, as an e-wallet transaction.

In accordance with the disclosed embodiments, one or more components of the system 100 may provide fraud detection in order to prevent unauthorized transactions. In particular, the components of the system 100 may provide localized and/or offline real-time fraud detection in order to detect the unauthorized transactions and/or unauthorized users before processing the transactions.

In some embodiments, one or more components of the system 100 may access behavior profile data at step 410. The behavior profile data may include but is not limited to information related to the mobile device user, other individuals with activities similar and/or dissimilar to the mobile device user, known fraudulent transactions, predetermined rules, etc. Using the behavior profile data, one or more components of the system 100 may determine a fraud detection model at step 420.

In one aspect, the components of the system 100 may use one or more statistical models to determine the fraud detection model. For example, one or more components of the system 100 may use a logistic model to determine the relationships within the behavior profile data. Using logistic regression, for instance, the components of the system 100 may determine one or more models for the regular behavior of the user, one or more models for the regular behavior of other individuals, one or more models for fraudulent transactions, or a combination of the various models, etc.

In another aspect, one or more components of the system 100 may use various data mining techniques to determine the fraud detection model. For example, the data mining techniques may include but are not limited to classification, clustering, decision trees, neural networks, etc. In yet another aspect, the components of the system 100 may use rule-based analysis to determine the fraud detection model.

In some embodiments, the fraud detection model may be determined real-time during the mobile transactions. In such embodiments, one or more components of the system 100 may access the behavior profile data at step 410, determine the fraud detection model at step 420, and proceed to compare the transaction data and behavior profile data during each transaction. In some embodiments, the fraud detection model may be determined in advance of the mobile transactions. For example, one or more components of the system 100 may determine the fraud detection model during an initial setup process, or during periodic or arbitrary updates. Moreover, the components of the system 100 may determine the fraud detection model as a background process and/or may update the fraud detection model whenever the behavior profile data is updated.

Based on the fraud detection model, one or more components of the system 100 may determine the risk of fraud. In some embodiments, for example, one or more components of the system 100 may calculate the probability of fraud at step 430. Depending on the type of fraud detection model, one or more components of the system 100 may use various techniques to calculate the probability of fraud. Logistic model, for instance, may associate the relationships within the behavior profile data using one or more characteristics. In such an instance, one or more components of the system 100 may use logistic regression analysis to find a probability of fraud. Thus, the components of the system 100 may compare the transaction data with the fraud detection model to determine the risk of fraud associated with the transaction. In another aspect, fraud detection model be one or more decision trees determined based on the behavior profile data. Each decision tree may comprise a root node, branches, internal nodes, and leaf nodes. In such an aspect, components of the system 100 may assign a specific probability to each node. Thus, by processing the transaction data through the various levels of nodes, one or more components of the system 100 may determine the probability of fraud associated with the transaction data. Other methods of calculating the probability of fraud may also be possible. For example, one or more components of the system 100 may use cluster analysis to classify groups of characteristics into similar clusters and determine the distance of the transaction data from the clusters to calculate the probability of fraud. It will be apparent to those skilled in the art that other techniques exist and the disclosed embodiments are not limited to the disclosed examples.

Depending on the type of fraud detection model, certain amount of error will always occur. For example, the errors may include but are not limited to false positives where authorized transactions are associated with a higher risk of fraud and false negatives where unauthorized transactions are associated with a lower risk of fraud, etc. In seeking to find the proper balance between the two error types, the system 100 may choose to favor one over another. For example, in some embodiments, the system 100 may use a fraud detection model with less false negatives, which may allow the system 100 to prevent greater fraudulent transactions. In some embodiments, the system 100 may use a fraud detection model with less false positives, which may allow the system 100 to increase speed and efficiency.

In some embodiments, the system 100 may reduce both false positives and false negatives by using additional user verification. For example, one or more components of the system 100 may reduce false negatives by using a more stringent fraud detection model. In such embodiments, one or more components of the system 100 may calculate the probability of fraud for a transaction at step 430 and may initiate user verification for any transaction associated with a high risk of fraud. The user verification may include, but is not limited to, entering a code received from the server 112 in one or more components of the system 100, a user pin, password, or the like. In some aspects, the authentication process may be a security challenge presented to the mobile device user. In such embodiments, if the user verification is successful, one or more components of the system 100 may proceed to process the transaction at step 450. Thus, by providing additional user verification at step 440, the system 100 may reduce false positives. In a further aspect, if the user verification is unsuccessful, one or more components of the system 100 may decline the transaction at step 460.

In some embodiments, one or more components of the system 100 may update the behavior profile data at step 470. By updating the behavior profile data, the system 100 may refine its fraud detection model to minimize errors. Thus, the system 100 may provide localized and/or offline real-time fraud detection that may be robust, fast, and with minimal error rate.

FIG. 5 shows a flowchart illustrating a sequence of steps that performs exemplary process 500 for dynamically processing e-wallet transactions in accordance to disclosed embodiments. In particular, FIG. 5 shows an exemplary process 500 for dynamically processing transactions between a merchant and a user of a mobile device. The process of FIG. 5 may be implemented in software, hardware, or any combination thereof. For purposes of explanation and not limitation, the process 500 will be described in the context of a mobile communications device in the system 100, such that the disclosed process may be performed by software executing in mobile devices 102, 104, 106, and 108, for example, as an e-wallet transaction.

In the aspect of a merchant transaction (e.g., in-store transaction or pop-up merchant location transaction, etc.), the merchant 116 may be configured to receive an electronic communication from the mobile communications device using a POS terminal, contactless payment terminal, or the like for processing financial transactions initiated from the mobile communications device. For example, the mobile device user may initiate a financial transaction from a mobile communications device by utilizing a NFC connection to communicate with a contactless payment terminal of the POS terminal. At step 510, the POS terminal in the system 100 may transfer the transaction data associated with the financial transaction to the mobile communications device. In one aspect, the transaction data may include, but is not limited to, information related to the purchase item, transaction amount, transaction time and date, merchant identifier, user identifier, etc.

After receiving the transaction data associated with the financial transaction, one or more components of the system 100 may initiate a fraud prediction process at step 520. In some embodiments, the fraud prediction process may be implemented locally on the mobile communications device. In such an embodiment, the mobile communications device may be equipped with its own offline fraud detection and prevention capabilities, which may include, for example, accessing a behavioral profile data to predict the likelihood of fraud. Examples of the fraud detection process are described above.

Using the behavioral profile data, at step 520, one or more components of the system 100 may compare the transaction data with the behavioral profile data to predict whether the transaction is fraudulent. Such a comparison may allow the components of system 100 to determine the likelihood that the current transaction is a normal or abnormal event. For example, the behavioral profile data may indicate that the mobile user frequently visits a local coffee shop around the user's work office during business hours. The behavioral profile data may further indicate that the mobile user never shops at a particular store or a category of stores. Furthermore, the behavior profile data may also indicate that a typical pattern of fraudulent transactions may start with multiple small purchases before an unusually large transaction occurs.

By comparing the current transaction data with the behavior profile data, one or more components of the system 100 may determine whether the transaction is likely to be fraudulent. For example, the current transaction data may indicate that the transaction is for a small purchase at the particular store the user never shops at and that the transaction is during business hours but not near the user's work office. The one or more components of system 100 may compare the transaction data with the behavior profile data and determine the risk that the transaction is fraudulent. In some embodiments, components of the system 100 may determine the risk of fraud as a probability.

In the foregoing example, if the received transaction data indicates that the transaction is completely abnormal and different from the user's behavior profile data, the system 100 may determine that there is a high risk of fraud. For example, the comparison between the transaction data and the behavior profile data may indicate that the pending transaction is at a jewelry store that is not near the user's work office or home, that the purchase price is atypical of the user's spending amount, and that the transaction time is during business hours. Based on the comparison, the system 100 may determine the specific risk of fraud associated with the transaction.

In some embodiments, the system 100 may further compare the transaction data with behavior profile data of individuals other than the user. For example, behavior profile data of other individuals may indicate that during February people often frequent jewelers to purchase gifts, or that during late May people often purchase gifts for Mother's day or for graduations, or that during December people may increase their spending, etc. By comparing the transaction data with behavior profile data of other individuals, the system 100 may adjust the risk assessment accordingly. The system 100 may lower the risk assessment, for example, if the transaction date is within certain days from Valentine's Day even though the user typically does not shop at that store. Or the system 100 may increase the risk assessment if the transaction fits the fraudulent pattern as described above. In some embodiments, the system 100 may use different weights for determining the risk based of whether the transaction is in-store or e-commerce.

In some embodiments, once the risk of fraud has been determined, one or more components of the system 100 may proceed to process the financial transaction at step 530. Traditionally, the transactions may be classified at least in one of two ways. First, the transaction may be classified as “Card Present” (i.e., as a “CP” transaction). In-store transactions are typically card-present transactions because the merchant can physically handle and examine the card. Thus, for example, if the merchant followed the required security protocols and minimized the possibility of fraud on its end, the issuer may bear all liability for unauthorized CP transactions. Second, the transaction may be classified as “Card Not Present” (i.e., as a “CNP” transaction). Mail-order, telephone order, and e-commerce transactions are typically card-not-present transactions because the merchant does not have the ability to examine the card. Moreover, e-wallet transactions initiated from the mobile communications device are typically classified as CNP transactions for the same reason. Thus, the merchants or the acquirers may bear all liability for unauthorized CNP transactions.

In accordance with disclosed embodiments, one or more components of the system 100, however, may dynamically process the transaction without adhering to predefined or automatically assigned classifications. For example, the system 100 may dynamically process in-store transactions as CP transactions or CNP transactions (or hybrids between the two), which may enable the system 100 to process additional transactions and/or dynamically shift liability.

At step 530, one or more components of the system 100 may determine whether to process the transaction as CP or as CNP based on the risk of fraud associated with the transaction. In one embodiment, the system 100 may compare the risk of fraud with a predefined threshold. The predefined threshold may be defined by the issuer 118 as the maximum acceptable level of risk. Thus, any risk below the predefined threshold may be acceptable to the issuer 118, and any risk above the predefined threshold may not be acceptable to the issuer 118. In some embodiments, components of the system 100 may determine whether the risk of fraud is acceptable to the issuer 118 based on preexisting rules of the issuer 118, the behavior profile data, and the like.

In one aspect, one or more components of the system 100 may determine that there is a low risk of fraud (e.g., the probability that the in-store transaction may be fraudulent is low). In such an aspect, components of the system 100 may process the transaction as CP at step 540. By classifying the transaction as CP, the liability that the transaction may be fraudulent will be borne by the issuer 118. In some embodiments, the system 100 may compare the risk of fraud against a predefined threshold. In such embodiments, one or more components of the system 100 may classified the transaction as CP if the risk of fraud is below the predefined threshold.

In another aspect, one or more components of the system 100 may determine that there is a high risk of fraud (e.g., the probability that the in-person transaction may be fraudulent is high). For example, at step 530, the system 100 may compare the risk of fraud to the predefined threshold and determine that the risk is above the predefined threshold of the issuer 118. In such an aspect, the system 100 may determine, through the predefined threshold, that the issuer 118 would not accept this high-risk transaction.

In a further aspect, at step 550, one or more components of the system 100 may send a message to the merchant 116, asking if the merchant 116 is willing to approve the transaction (e.g., to accept the risk). For example, the mobile communications device may communicate to the POS terminal that the risk of fraud is above a predefined threshold. The POS terminal (e.g., associated with the merchant 116) at step 550 may then decide whether to allow the transaction or to reject the transaction. In one aspect, the POS terminal may decide to reject the transaction. In such an aspect, the transaction may be denied at step 560. However, in another aspect, the POS terminal may decide to allow the transaction. For example, the merchant 116 may have preexisting rules to approve certain transactions under limited circumstances. In such an aspect, the system 100 may process the transaction as CNP at step 570. Once the transaction is processed as CNP, the liability for fraud may be shifted to the merchant 116, who allowed the transaction. In other embodiments, step 550 is optional and need not be performed.

In some embodiments, at step 570 (e.g., if the issuer 118 refuses to take the risk but the merchant 116 agrees), one or more components of the system 100 may determine the proportion of liability to be borne by the merchant 116. For example, the system 100 may determine the proportion of liability based on the proportion of risk relative to the predefined threshold. Alternatively, the system 100 may determine the proportion of liability based on predefined rules and/or other algorithms (e.g., with simple direct correlation between risk and liability to shift, or inverse correlation between the two). In such embodiments, the system 100 may optionally allow proportionality of the liability at a cost to the merchant 116.

By utilizing fraud detection, one or more components of the system 100 may provide improved techniques for dynamically processing in-store transactions. Moreover, components of the system 100 may provide several advantages. For example, the system 100, utilizing the disclosed techniques, may allow significantly more transactions based on its ability to classify in-store transactions as both CP and CNP. At the same time, one or more components of the system 100 may also minimize the risk of fraud due to its ability to perform real-time fraud detection with finer granularity in risk assessment.

FIG. 6 shows a flowchart illustrating a sequence of steps that performs exemplary process 600 for dynamically processing e-wallet transactions in accordance with disclosed embodiments. In particular, FIG. 6 shows an exemplary process 600 for dynamically processing e-commerce transactions. The process of FIG. 6 may be implemented in software, hardware, or any combination thereof. For purposes of explanation and not limitation, the process 600 will be described in the context of a mobile communications device in the system 100, such that the disclosed process may be performed by software executing in mobile devices 102, 104, 106, and 108, for example, as an e-wallet transaction.

Exemplary steps 610 and 620 of process 600 may be implemented according to exemplary processes as discussed above, with the exception that the financial transaction may be initiated via the web or within an application of the mobile communications device. Thus, when the user makes an online purchase or in-app purchase, the mobile communications device may perform fraud prediction before processing the transaction in accordance with the disclosed embodiments.

During fraud prediction, one or more components of the system 100 may access the user's behavior profile data. The user's behavior profile data, for example, may comprise behavior-based information gathered from the user's online activities. For example, the information may describe the user's shopping habits, typical web browsing activities, browsing histories, search histories, mobile device usages, and the like. The user's shopping habits, for example, may include information related to the user's favorite online merchants, the typical purchase items, the transaction amounts, transaction time, etc. The user's typical web browsing activities, on the other hand, may include information related to the user's general web surfing behavior. By tracking the user's online activities, the system 100 may determine a pattern describing the user's online behavior. For example, the pattern may show that the user spends significantly more time online during nighttime or that the user tends to access certain websites (or categories of website) or shopping portals during specific time periods (e.g., more often at night as opposed to during work hours).

In addition to information of the user's general activities, the behavior profile data may include specific information related to the user's online activities including but not limited to the user's search history, browsing histories, etc. Specific information such as search and browsing histories may be especially useful for fraud detection, because the information may be used as feedforward, which may allow one or more components of the system 100 to predict what the user could purchase in the future. For example, the user may have spent the last month searching for a specific product. The behavior profile data, therefore, may contain information related to how often the user reads about the specific product, the various website the user visited concerning the specific product, the various searches related to the specific products, etc. Using the behavior profile data, one or more components of the system 100 may predict that the user may purchase the specific product in the near future and the possible transaction amount for such purchase. Thus, by comparing the behavior profile data and the transaction data, the system 100 may determine the risk of fraud associated with the transaction.

Once the system 100 has determined the risk of fraud associated with the financial transaction, one or more components of the system 100 may dynamically process the transaction at step 630. For example, the system 100 may dynamically process e-commerce transactions as CP transactions or CNP transactions, which may enable the system 100 to process additional transactions traditionally not allowed.

In some embodiments, one or more components of the system 100 may have a predefined threshold for processing the transaction. The predefined threshold may indicate, for example, the maximum risk the issuer 118 may be willing to accept if the transaction is allowed. In such embodiments, the system 100 may compare the risk of fraud with the predefined threshold at step 630. In some embodiments, the system 100 may determine whether the issuer 118 may be willing to approve the transactions based on the preexisting rules of the issuer 118, behavior profile data, etc.

In one aspect, one or more components of the system 100 may determine that the risk is sufficiently low (e.g., below the predefined threshold). In such an aspect, the system 100 may communicate to the merchant 116 that the issuer 118 may be willing to take the risk at step 640.

Traditionally, e-commerce transactions are processed as CNP transactions, and the associated liabilities are borne by the merchant 116. System 100, however, may allow dynamic processing of the transactions. Thus, at step 640, one or more components of the system 100 may enable the merchant 116 to make a determination over whether to process the transaction as CP or as CNP. In such an aspect, if the merchant 116 agrees to shift the liability risk to the issuer 118, the system 100 may approve the transaction as CP at step 650a. Thus, the liability will be borne by the issuer 118. In some embodiments, the system 100 may enable the merchant 116 to shift the liability risk to the issuer 118 at a cost to the merchant 116. Thus, in such an embodiment, the merchant 116 may have to pay additional transaction fees to process e-commerce transactions as CP.

In another aspect, the merchant 116 may not want to process the transaction as CP. For example, the merchant 116 may not agree to shift the liability risk, or the merchant 116 may not want to pay the additional transaction cost, etc. In such an aspect, one or more components of the system 100 may process the transaction as CNP at step 650b. Thus, the transaction may be processed as a CNP transaction, and the liability will be borne by the merchant 116. In some embodiments, the system 100 may provide a discounted transaction fee if the merchant 116 does not shift the liability risk to the issuer 118.

In a further aspect, one or more components of the system 100 may compare the behavior profile data and the transaction data and determine that the risk of fraud associated with the transaction is high. For example, the risk of fraud may exceed the predefined threshold. In such an aspect, one or more components of the system 100 may not suggest to shift the liability to the issuer 118. Instead, components of the system 100 may prompt the merchant 116 to allow or deny the transaction at step 660. If the merchant 116 allows the transaction (or accepts to assume the risk), then the system 100 may process the transaction as CNP.

However, if the merchant 116 denies the transaction, in some embodiments, one or more components of the system 100 may shift the decision to the issuer 118. For example, if the merchant 116 rejects the transaction, the system 100 may determine whether the issuer 118 may approve the transaction. For example, the issuer 118 may have preexisting rules for certain risky transactions to be approved under limited situations. For example, the issuer 118 may have different rules for business accounts, high wealth individuals, cardholder preferred statuses, etc. In such embodiments, one or more components of the system 100 may determine if issuer 118 may be willing to approve high-risk transactions. If the system 100 determines that the issuer 118 may be willing, then the system 100 may approve the transaction as CP at step 690a. Thus, the liability may be borne by the issuer 118. In some embodiments, one or more components of the system 100 may enable the merchant 116 to shift the decision to the issuer 118 at a cost to the merchant 116 at step 680. In such an embodiment, the merchant 116 may have to pay an additional transaction fee to process the e-commerce transaction as CP.

In a further aspect, one or more components of the system 100 may determine that the issuer 118 may not approve high-risk transactions. Thus, the system 100 may deny the e-commerce transaction at step 690b.

By utilizing fraud detection, one or more components of the system 100 may provide improved techniques for dynamically processing e-commerce transactions. The improved techniques may allow significantly more transactions by allowing the system 100 to process e-commerce transactions as both CP and CNP. Furthermore, the system 100 may reduce the overall transaction costs and minimize the risk of fraud due to its ability to perform real-time risk assessment and fraud prediction with finer granularity.

Other embodiments will be apparent to those skilled in the art from consideration of the specification and practice of the disclosed embodiments. It is intended that the specification and examples be considered as exemplary only, with a true scope and spirit of the disclosed embodiments being indicated by the following claims. It is to be understood that the examples and descriptions in this disclosure have been arbitrarily defined herein for the convenience of the description. The disclosed systems and methods are not limited to these simplified examples, and other features and characteristics may be considered so long as the specified functions are appropriately performed.

While certain disclosed embodiments have been discussed with respect to mobile devices and e-wallet transactions for purposes of discussion, one skilled in the art will appreciate the useful applications of disclosed methods and systems for dynamically processing financial transactions including all methods of payments from a customer to merchants through a third entity systems (e.g., acquirers and issuers). Furthermore, although aspects of the disclosed embodiments are described as being associated with data stored in memory and other tangible computer-readable storage mediums, one skilled in the art will appreciate that these aspects can be stored on and executed from many types of tangible computer-readable media. Further, certain processes and steps of the disclosed embodiments are described in a particular order, one skilled in the art will appreciate that practice of the disclosed embodiments are not so limited and could be accomplished in many ways. Accordingly, the disclosed embodiments are not limited to the above-described examples, but instead are defined by the appended claims in light of their full scope of equivalents.

What is claimed is:

1. A non-transitory computer readable medium storing instructions that, when executed by at least one processor, cause the at least one processor to perform operations for dynamically processing mobile transactions comprising:
enabling, on a mobile communications device, initiation of a requested mobile transaction from the mobile communications device, wherein a user's financial account information is stored in the mobile communications device for electronic communication to a merchant;
receiving from the merchant, in the mobile communications device, transaction data associated with the requested mobile transaction;
accessing, without resort to a remote payment processing network server, behavioral profile data stored locally in the mobile communications device;
comparing, on the mobile communications device, the transaction data with the behavioral profile data;
determining, on the mobile communications device, based on the comparing, a risk of fraud associated with the requested mobile transaction; and
enabling on the mobile communications device, based on the determined risk of fraud, liability for the requested mobile transaction to be shifted between the merchant and an issuer of the financial account.

2. The non-transitory computer readable medium of claim 1, wherein the behavioral profile data stored on the mobile communications device includes information about behaviors of individuals other than the user.

3. The non-transitory computer readable medium of claim 1, wherein the enabling based on the determined risk of fraud includes checking the determined risk of fraud against at least one threshold, and shifting the liability to the issuer if the determined risk of fraud passes the at least one threshold.

4. The non-transitory computer readable medium of claim 1, wherein the instructions further cause the at least one processor to enable the merchant to make a determination over whether the liability should be shifted to the issuer.

5. The non-transitory computer readable medium of claim 1, wherein the merchant is enabled to shift the liability to the issuer at a cost to the merchant.

6. The non-transitory computer readable medium of claim 1, wherein the instructions further cause the at least one processor to prompt the user to provide additional security information, and wherein the determining of the risk of fraud is based on the behavioral profile data and the additional security information.

7. The non-transitory computer readable medium of claim 1, wherein the enabling based on the determined risk of fraud includes determining a proportion of liability to be borne by the merchant if the requested mobile transaction is fraudulent.

8. The non-transitory computer readable medium of claim 1, wherein the instructions further cause the at least one processor to offer a discount to the merchant associated with the requested mobile transaction based on the determined risk of fraud.

9. A mobile communications device configured for dynamically processing mobile transactions comprising:
a memory storing executable instructions; and
at least one processor configured to execute the stored instructions to:
enable, on the mobile communications device, initiation of a requested mobile transaction from the mobile communications device, wherein a user's financial account information is stored in the mobile communications device for electronic communication to a merchant;
receive from the merchant, in the mobile communications device, transaction data associated with the requested mobile transaction;
access, without resort to a remote payment processing network server, behavioral profile data stored in the mobile communications device;
compare, on the mobile communications device, the transaction data with the behavioral profile data;
determine, on the mobile communications device, based on the comparison, a risk of fraud associated with the requested mobile transaction; and
enable on the mobile communications device, based on the determined risk of fraud, liability for the requested mobile transaction to be shifted from the merchant to an issuer of the financial account.

10. The mobile communications device of claim 9, wherein the behavioral profile data stored on the mobile communications device includes information about behaviors of individuals other than the user.

11. The mobile communications device of claim 9, wherein the enabling based on the determined risk of fraud includes checking the determined risk of fraud against at least one threshold, and shifting the liability to the issuer if the determined risk of fraud passes the at least one threshold.

12. The mobile communications device of claim 9, wherein the at least one processor further configured to enable the merchant to make a determination over whether the liability should be shifted to the issuer.

13. The mobile communications device of claim 9, wherein the merchant is enabled to shift the liability to the issuer at a cost to the merchant.

14. The mobile communications device of claim 9, wherein the at least one processor is further configured to prompt the user to provide additional security information, and wherein the determination of the risk of fraud is based on the behavioral profile data and the additional security information.

15. The mobile communications device of claim 9, wherein the enabling based on the determined risk of fraud includes determining a proportion of liability to be borne by the merchant if the requested mobile transaction is fraudulent.

16. The mobile communications device of claim 9, wherein the at least one processor is further configured to offer a discount to the merchant associated with the requested mobile transaction based on the determined risk of fraud.

17. A computer-implemented method for dynamically processing mobile transactions, the method comprising:
enabling initiation of a requested mobile transaction from a mobile communications device, wherein a user's financial account information is stored in the mobile communications device for electronic communication to a merchant;
receiving from the merchant, in the mobile communications device, transaction data associated with the requested mobile transaction;
accessing, without resort to a remote payment processing network server, behavioral profile data stored in the mobile communications device;
comparing the transaction data with the behavioral profile data;
determining, on the mobile communications device, based on the comparing, a risk of fraud associated with the requested mobile transaction; and
enabling, based on the determined risk of fraud, liability for the requested mobile transaction to be shifted from the merchant to an issuer of the financial account.

18. The computer-implemented method of claim 17, wherein the enabling based on the determined risk of fraud includes checking the determined risk of fraud against at least one threshold, and shifting the liability to the issuer if the determined risk of fraud passes the at least one threshold.

19. The computer-implemented method of claim 17, the method further comprising enabling the merchant to make a determination over whether the liability should be shifted to the issuer.

20. The computer-implemented method of claim 17, wherein the enabling based on the determined risk of fraud includes determining a proportion of the liability to be borne by the merchant if the requested mobile transaction is fraudulent.
